(19) United States
(12) Patent Application Publication
(10) Pub. No.: US 2008/0111654 A1
(43) Pub. Date: May 15, 2008

(54) Transmission Arrangement

(76) Inventors: Patrik Rivas, Alingsas (SE); Andreas Berndtsson, Goteborg (SE)

Correspondence Address: ERICSSON INC., 6300 LEGACY DRIVE, M/S EVR 1-C-11, PLANO, TX, 75024, US

(21) Appl. No.: 11/720,276

(22) PCT Filed: Nov. 30, 2004
(86) PCT No.: PCT/SE04/01777

§ 371 Date: Jul. 13, 2007

(51) Int. Cl. H01P 3/08

(52) U.S. Cl. 333/247

(57) ABSTRACT

The invention relates to a microwave transmission arrangement (10) comprising a carrier substrate (1), with a microstrip transmission line, on a first side of the carrier substrate (1), said carrier substrate (1) comprising at least one opening (2; 2′) forming a waveguide input/output opening to a waveguide arrangement. The transmission line comprises a microstrip conductor, a first end of which at least partly is disposed at one of said waveguide openings (2; 2′), and comprises a first conductor portion (4₁) substantially at the center of said opening (2) and extends in a direction substantially parallel with a longitudinal extension of the transmission arrangement (10), a second conductor portion (4₂) substantially perpendicular to said first conductor portion, said first and second conductor portions substantially forming a T, said second portion (4₂) via a first bend (6₁) forming the transfer to a third conductor portion (4₃), said second and third conductor portions forming an angle of substantially 90° with each other. The third conductor portion transfers into fourth (4₄) and fifth (4₅) conductor via second (6₂) and third (6₃). An adapting element (5) is arranged substantially at said third bend (6₃).

### FIELD OF THE INVENTION

The present invention relates to a transmission arrangement comprising a carrier substrate with at least one opening acting as a waveguide input/output opening to a waveguide arrangement, a microstrip line being provided on a first side of said carrier substrate.

The invention also relates to a waveguide arrangement comprising a number of transmission arrangements each comprising a carrier substrate with at least one opening acting as waveguide input/output and a microstrip line provided on a microstrip carrier, each of said transmission arrangements being connected to said waveguide arrangement, which e.g. comprises a waveguide block.

The invention particularly relates to a microstrip-waveguide-transition arrangement for providing a transition between a microstrip line and a waveguide.

### STATE OF THE ART

For transmission of microwaves (RF waves, microwaves or millimeterwaves) it is well known to use different transmission techniques or transmission medias. The use of waveguides is extremely advantageous since, when waveguides are used, the losses are extremely small or practically there are no losses at all, and it is also a comparatively cheap technique. Microstrips or microstrip lines, on the other hand, are extremely advantageous in that active components, such as for example resistors, amplifiers etc. can be mounted directly on top of the microstrip board, i.e. surface mounted. (A microstrip transmission line generally consists of a conductive strip and a ground plane separated by a dielectricum, and it is a widely used microwave transmission technique, particularly for microwave integrated circuits and MMICs, Monolithic Microwave Integrated Circuits.) However, generally a quite high isolation is required and the losses are not as low as when waveguides are used.

It has hence be realized that it would be very attractive to combine the waveguide and microstrip transmission technologies. This, however, requires transitions between microstrips and waveguides. Problems that are associated with providing a transition between a waveguide and a microstrip relate to large insertion losses as well as high return losses, and so far no satisfactory solution has been found to solve the problem of providing a satisfactory transition between waveguide and microstrip, and hence to provide transmission arrangements comprising such transitions.

It is therefore an object of the present invention to provide a transmission arrangement as initially referred to which provides for a transition between a microstrip and a waveguide and which has low return losses and/or low insertion losses. Particularly it is an object of the invention to provide such an arrangement which is easy and cheap to manufacture. Still further it is an object of the invention to provide an arrangement as initially referred to which can be used in a flexible manner within a large number of fields, for example within antenna technology e.g. in telecommunications systems or in radio technology in general. It is also an object of the invention to provide a waveguide arrangement on which a number of transmission arrangements, providing for transitions between microstrip and waveguide, can be mounted. Particularly it is an object of the invention to provide an arrangement as referred to above which comprises a module which, as a single module, or in combination with a plurality of similar (or other) modules, can be mounted on a waveguide block.

Therefore a transmission arrangement as initially referred to is suggested, wherein the microstrip transmission line comprises a microstrip carrier with a microstrip conductor. A first end of said microstrip conductor is at least partly disposed at one of said waveguide openings and it comprises a first conductor portion disposed on said microstrip carrier arranged on said first side of the carrier substrate substantially at the center of said at least one opening and it extends in a direction substantially parallel with the longitudinal extension of the transmission arrangement. A second conductor portion extends substantially perpendicularly to said first conductor portion and it is so disposed that said first and second portions substantially form a T, said second portion via a first bend turning into a third conductor portion such that said second and third conductor portions form an angle of substantially 90° with each other. Said third portion via a second bend forms a transfer to a fourth conductor portion extending substantially parallelly with said second conductor portion, a third bend being provided to form a transfer to a fifth conductor portion substantially parallel with said third conductor portion but which is displaced a distance towards a longitudinal centerline of the transmission arrangement. Said distance substantially corresponds to the length of said fourth conductor portion, and at the portion(s) of the substrate layer comprising the opening(s) associated with said at least one waveguide opening, a respective quarter wavelength (λ/4) waveguide termination is disposed. (λ e.g.=λ_{g}=λ₀/(1−(λ₀/λ_{C})⁰⁵; λ_{C} being the cut-off frequency of the waveguide or λₛ=C₀/f\sqrt{∈ᵣ}, the microstrip wavelength.) An adapting element is arranged substantially at said third bend and the arrangement comprises at least one transition between the microstrip transmission line and a waveguide arrangement.

Particularly the transmission arrangement comprises an opening forming a second waveguide opening disposed at the opposite side of the longitudinal extension of the transmission arrangement. Said microstrip conductor, at said second waveguide opening, comprises second end first to fifth conductor portions and second end first, second and third bends similar to those, first end, conductors/bends, associated with said first waveguide opening and located in the same plane, but rotated 180° with respect thereto.

In an advantageous implementation a power amplifier is disposed on the waveguide arrangement such as to cover an intermediate portion of said carrier substrate at a distance from said third bends and the fifth conducting portions are connected to said power amplifier.

Preferably the carrier substrate comprises a dielectric material, e.g. with a (relative) dielectric constant (∈ᵣ) selected e.g. between 2-200 depending on application.

In one implementation the carrier substrate comprises a ferroelectric material.

The microstrip carrier preferably comprises a microstrip laminate, e.g. a dielectric or ferroelectric material, and the conductors preferably comprises Cu, Ag, Au or similar provided in/on, e.g. etched in, said laminate.

In one advantageous implementation the microstrip carrier material or laminate comprises Duroid 5870 or a similar material.

The width of the conductor preferably lies between 9.9-1.3 mm, particularly it is about 1.12 mm. However, other widths or thicknesses are of course also possible.

In a particular implementation a rectangular recess is formed on the second side of said carrier substrate, the height of which e.g. corresponds to the height of a waveguide comprised by the waveguide arrangement.

Generally the waveguide arrangement comprises Al or a similar material.

In preferred implementations the adapting means are provided close to the, or each, third bend. In a most preferred implementation the adapting means are provided substantially at the middle of the, or each, third bend. Most particularly the adapting means, or the adapting element, comprises Al, e.g. an Al-film. Most preferably said adapting means comprises a wire or a filament of Al or a material with similar properties.

It has turned out to be extremely advantageous if the wire of e.g. Al has a width or thickness of approximately 0.3-0.7 mm, e.g. 0.5 mm, and a length of approximately 2-6 mm, particularly about 4 mm.

Preferably the adapting means are soldered onto the conductor portions at the respective third bend. Further, most advantageously, said first and second portions substantially assume the shape of T:s, and comprise probes located substantially at the center of the respective waveguide opening.

Particularly said third bends are substantially 90° bends, such that interconnected portions are interconnected at substantially 90°. Alternatively at least some of the bends provide interconnections for which interconnected conducting portions form an angle with each other exceeding 90° (or being smaller than 90°).

In a most advantageous implementation the transmission arrangement comprises a module, even more particularly a MMIC (Monolithic Microwave Integrated Circuit).

The invention also provides a waveguide arrangement for transmission of microwaves/millimeterwaves including a waveguide block with a number of waveguide input/output openings. At least on a number of said waveguide input/output openings microwave/millimeter transmission arrangements, as discussed above, are provided.

The waveguide arrangement may in addition comprise means for providing a transition to a coaxial transmission arrangement.

The invention also relates to the use of transmission arrangements, or a waveguide arrangement as discussed above, in an antenna system.

### BRIEF DESCRIPTION OF THE DRAWINGS

The invention will in the following be further described in a non-limiting manner, and with reference to the accompanying drawings, in which:

FIG. 1 is a perspective view of a microwave transmission arrangement according to one embodiment of the invention,

FIG. 2 is a top view of the input side of the arrangement of FIG. 1,

FIG. 3 is a top view of the output side of the arrangement of FIG. 1,

FIG. 4 is a diagram illustrating verification results of the transition (in dB) versus microwave frequency for an arrangement according to the inventive concept, and

FIG. 5 schematically shows a waveguide arrangement with transmission arrangements according to the invention.

### DETAILED DESCRIPTION OF THE INVENTION

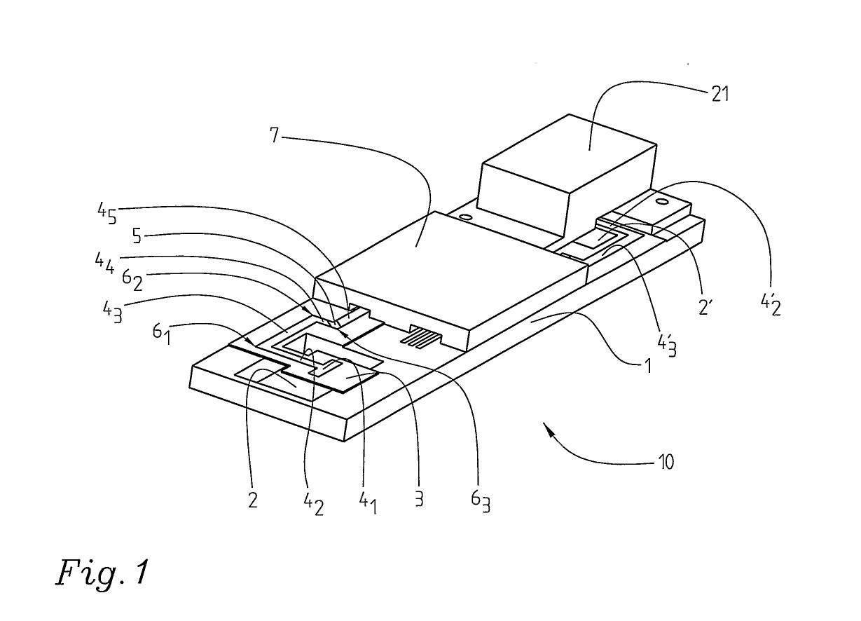

FIG. 1 shows a microwave transmission arrangement 10 which comprises a carrier substrate 1 which preferably is a dielectric or ferroelectric material. The dielectric constant is particularly selected depending on the frequency of the microwaves to be handled and generally it has a value between 2 and 200. Although the invention is not restricted thereto, even higher values may be used for some particular implementations.

In this particular implementation it is supposed that the transmission arrangement 10 comprises a carrier substrate 1 with two openings 2, 2′ forming input/output respectively to a waveguide (not shown in this figure) but on which the transmission arrangement 10 is provided or mounted. A microstrip carrier substrate 3, which also is a dielectric or a ferroelectric, is mounted on the carrier substrate 1 and it is mounted such as to at least cover a part of the waveguide input/output means 2, 2′. A microstrip conductor is provided in/on the microstrip carrier 3 as will be further described below. The microstrip conductor may particularly be manufactured on the microstrip substrate comprising a laminate, e.g. etched out. The microstrip carrier 3 preferably comprises a dielectric or ferroelectric material, and it is also selected such as to have a dielectric constant ∈ which is appropriate for the microwaves and millimeter waves to be handled, i.e. it is selected in dependence of their frequency. One example of a substrate carrier laminate material is Duroid 5870 (15 MIL, (1 MIL=25.4 μm) with 2×17 μm Cu). The conductor may have a width of 1.12 mm; this obviously relates to one particular way of carrying out the invention, the width or the thickness of the RF conductor may of course also be smaller as well as larger.

On the backside of the carrier is particularly a rectangle etched which has dimensions which are such that the microstrip can be mounted on the waveguide. Substantially at the center of the input/output openings the conductor comprises a respective probe essentially in the form of a T, and consisting of a first conductor portion 4₁ parallel with the lengthwise extension of the opening 2; 2′ or parallel with the longitudinal extension of the transmission arrangement 10. Perpendicularly to said first conductor portion 4₁ a second conductor portion 4₂ is disposed (the first and second conductor portions hence forming the T) and it extends transversally to the longitudinal extension of the transmission arrangement 10 (or the carrier substrate 1) and, after a first bend 6₁, it proceeds with a third conductor portion 4₃ which extends perpendicularly (at least substantially) to said second conductor portion 4₂ and hence substantially parallel with the first conductor portion 4₁ and with the longitudinal extension of the transmission arrangement 10. At a second bend 6₂ the third conductor portion 4₃ turns into a fourth conductor portion 4₄ which is substantially parallel with the second conductor portion 4₂, and after a third bend 6₃ the fourth conductor portion 4₄ is followed by, or turns into a fifth conductor portion 4₅ which is substantially parallel with the third conductor portion 4₃, and substantially perpendicular to the fourth conductor portion 4₄. Substantially at the third bend 6₃ adapting means are provided 5. Said adapting means 5 provide for a tuning or trimming enabling particularly low losses and a good adaptation, and the adapting means 5 has as a function to adapt the bends of the conductors such that they are related to each other in an optimized manner and hence optimizing the electrical performance. According to different embodiments the adapting means 5 are provided close to the third bend 6₃, in a particularly advantageous embodiment substantially in the middle of the respective third bend 6₃.

In one particular embodiment the adapting means 5 comprises an Al wire. In a particularly advantageous implementation the wire 5 has a thickness of about 0.5 mm and a length of about 4 mm. It should be clear that this merely relates to one particular embodiment which has been shown to be particularly advantageous; of course it can be varied and also adapted to the width of the conductor and to the length thereof. Also for the conductors with the same thickness and length, the thickness and the length of the wire may of course be varied for example between 0.4 mm to 0.6 mm for the width and for the length between 3-6 mm etc. Particularly the adapting means or the wire 5 is soldered onto the conductor substantially in the middle of the third bend seen from the waveguide input/output opening 2, 2′, or to the bend forming the first bend after a power amplifier 7 mounted on the carrier substrate 1 and to which the conductor 4₅ (and correspondingly on the output side, not shown) is connected in a conventional manner, which however does not form part of the present invention.

The arrangement also comprises a quarter wavelength (λ/4) waveguide 21 mounted on the regular waveguide (not shown), but with a gap, i.e. the microstrip conductor on the substrate carrier 3 is placed on the gap. In the figure merely the λ/4 termination 21 disposed at the output side is shown, it should however be clear that a λ/4 termination also is disposed in a similar manner at the input side, but for reasons of clarity it is not shown as well as the disposal of the microstrip conductor is not explicitly visible in FIG. 1 on the output side, but it is similarly disposed as on the input side with the difference that it is rotated 180° with respect thereto, in the same plane.

The transmission arrangement 10 hence forms a transition (or two, one at the input, one at the output) between microstrip and waveguide. It should be clear that various different components may be surface mounted on the microstrip conductor since a microstrip is extremely advantageous for surface mounting, whereas the waveguide on the other hand, has very low losses and can handle high powers.

Most advantageously the respective T shaped part of the conductor, i.e. the respective first and second conductor portions, are located at the center of the waveguide opening 6 and act as probes. Of course also in this respect some variations are possible as far as the location is concerned.

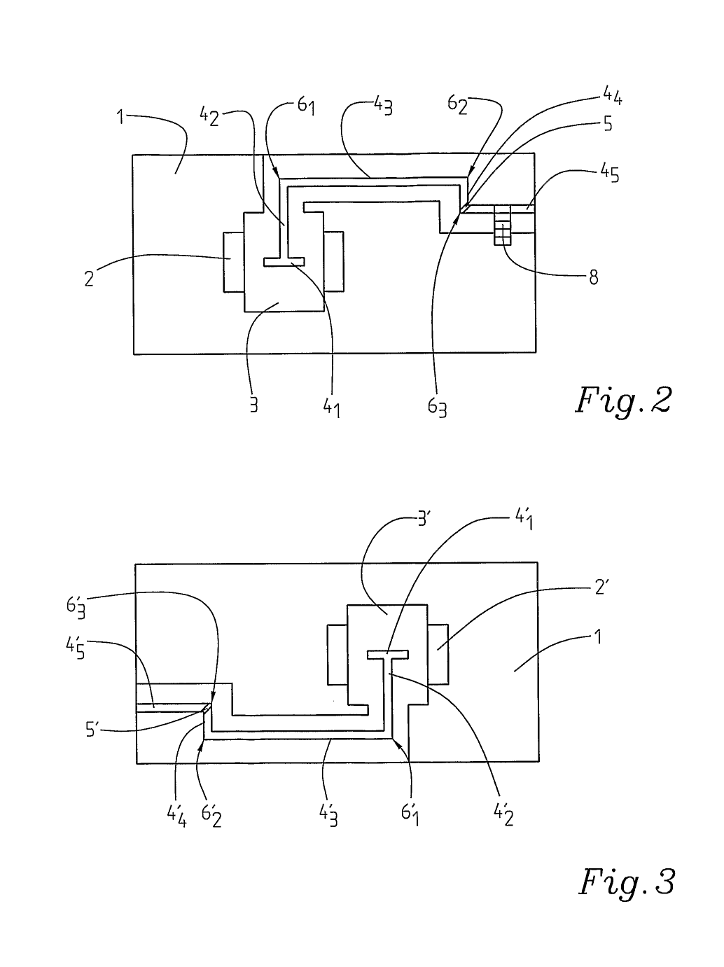

FIG. 2 is a schematical top view of the transmission arrangement 10 on the waveguide input side, i.e. it shows the T shaped first and second conductor portions 4₁, 4₂, the first bend 6₁, the third conductor portion 4₃, the second bend 6₂, the fourth conductor portion 4₄, the third bend 6₃ with the adapting means 5 and part of the fifth conductor portion 4₅ before it is connected to the power amplifier, which is not shown in this figure. In the figure a phase adapting circuit 8 is shown which is connected to the fifth conductor portion 4₅. Particularly the purpose thereof (i.e. of the phase adapting circuit 8), in a waveguide arrangement on which several transmission arrangements 10 are implemented in the form of modules provided on the microwave arrangement, is to adapt the latter to each other and make them experience the same environment as far as the phase etc. of the microwave is concerned.

As can be seen from FIG. 2 the T-shaped part of the conductor, i.e. conductor portions 4₁, 4₂, are disposed on the microstrip carrier or laminate 3 in a centralized manner with respect to the waveguide input opening 2, i.e. the opening in the substrate 1 functioning as an input to the waveguide (not shown).

FIG. 3 is a figure similar to FIG. 2 but showing the waveguide output side as shown in FIG. 1, but with the quarter wavelength termination removed for reasons of clarity. Hence, the carrier substrate 1 is provided with an opening 2′ forming a waveguide output opening and a microstrip carrier laminate 3′ with a conductor etched therein and, like in FIG. 2, comprising a first conductor portion 4′₁, a second conductor portion 4′₂, a first bend 6′₁, a third conductor portion 4′₃, a second bend 6′₂, a fourth conductor portion 4′₄, a third bend 6′₃ and a fifth conductor portion 4′₅, all disposed in a manner similar to what is disclosed in FIG. 2, but rotated 180° with respect thereto in the planar extension of the transmission arrangement 10. Substantially at the third bend 6′₃ from the waveguide output side or waveguide output opening 2′, an adapting element 5′ is provided. Similar to the fifth conductor portion 4₅ on the input side, the fifth conductor portion 4′₅ is connected to the power amplifier (not shown).

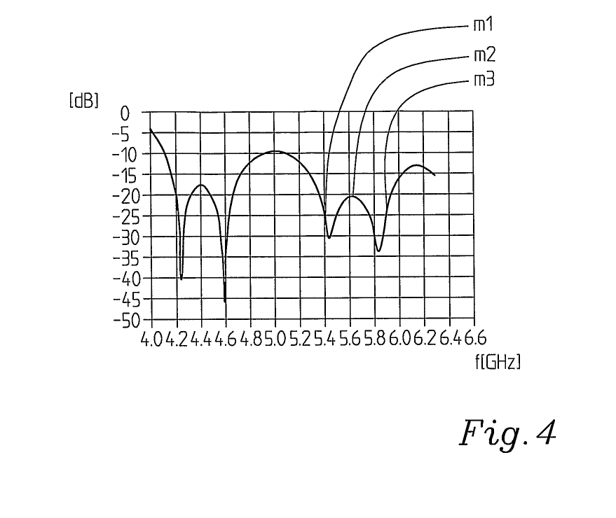

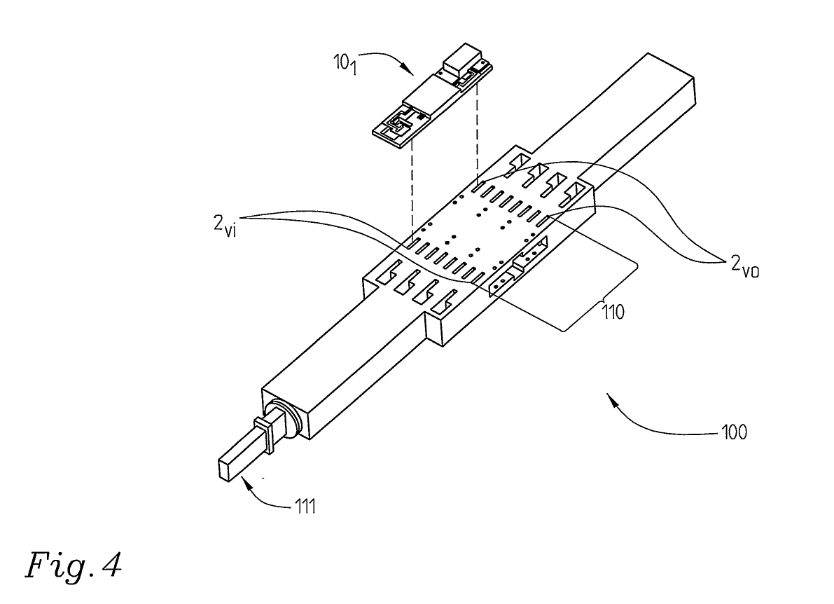

FIG. 4 is a diagram illustrating experimental results for signals within the C-band, i.e. for frequencies substantially between 5.4 GHz-5.9 GHz for a transmission arrangement according to the present invention comprising transitions between a microstrip line and a waveguide. In the experimental arrangement it is supposed that 16 MMIC:s are provided on power modules which are combined into a waveguide network, which requires microstrip-to-waveguide transitions, which hence are provided according to the inventive concept. The conductor has been etched in the material Duroid 5870 (15 MIL, 2×17 μm Cu) (∈ᵣ=2.33, thickness 0.38 μm) and the width of the RF-conductors is 1.12 mm. On the backside a rectangle had been etched corresponding to a half height C—band waveguide and on the other side a probe (cf. FIG. 1) is etched symmetrically in the waveguide opening. The probe, i.e. the portions of the conductor forming a T, (e.g. 4₁, 4₂ and 4₁′, 4₂′ of FIGS. 1-3) respectively are centralized with respect to the corresponding waveguide openings since the E-field (electrical field component) is strongest there. In order to perform the measurements, two structures were interconnected back-to-back and a calibration was performed in a conventional manner. The instrument that was used for performing the analysis was an appropriate network analyzer.

The best results were achieved if the probes were provided at the centers of the openings as referred to above. It was also established that the length of the first conductor portion 4₁, 4₁′ should not be too short. Through centralized location of the probes and through adapting means 5 comprising an Al wire with a thickness of about 0.5 mm and a length of about 4 mm soldered onto the third bends as referred to above or onto the first bends seen from the input of the power amplifier, measured results with better than −20 dB adaptation and better than 0.6 dB in losses resulted throughout the frequency band. m1, m2, m3 in FIG. 4 correspond to the frequencies 5.398 GHz, 5.612 GHz and 5.898 GHz respectively and the corresponding adaptation values were −26.752 dB, −20.703 dB and −24.547 dB respectively.

FIG. 5 is a schematical illustration showing a waveguide block 100 which for example may comprise a transition 111 to a coaxial cable. It should be clear that such a transition is not of any relevance for the present invention but it is merely illustrated for the purposes of indicating that such an arrangement (100) can be used in a large number of different implementations.

2ᵥᵢ indicate 8 waveguide inputs and 2ᵥₒ indicate 8 waveguide outputs for mounting of transmission arrangements or modules as described with reference to FIG. 1, here denoted 101, and only one such module being shown in an enlarged scale with respect to the waveguide block 100. Here these modules 101 can be mounted on top of the waveguide block 100 and similarly further modules (not shown) may be mounted on the opposite side of the waveguide block 100. It should be clear that the invention of course not is limited to a waveguide block as in FIG. 5 and also not to the mounting of the illustrated number of modules, but that substantially any appropriate number of modules can be mounted on a waveguide arrangement in any desired manner; the intention of the figure merely being to illustrate how and where a number of transmission arrangements can be arranged on a waveguide arrangement, hence including a number of microstrip-to-waveguide transitions. Hence, here the 8 modules can be mounted in the area schematically indicated 110 in the figure.

It should be clear that the openings 2, 2′ (cf. Fig) of the transmission arrangements are to be mounted on corresponding openings 2ᵥᵢ, 2ᵥₒ.

It should also be clear that the invention of course not is limited to the specifically illustrated embodiments but that it can be varied in a number of ways, particularly different materials can be selected for each of the constituent component and a transmission arrangement can be used single or unique as connected to a waveguide arrangement but the inventive concept may also be implemented such that a plurality of such modules (transmission arrangements) are mounted on a waveguide arrangement, e.g. a waveguide block. It should also be clear that various components, particularly active components, can be mounted easily on the microstrip according to the invention whereas the waveguide arrangement is capable of handling a high power with substantially no losses, such that it is extremely advantageous that both the advantages of a microstrip and those of a waveguide can be exploited or taken advantage of in an optimal way.

1.-26. (canceled)

27. A microwave/millimeterwave transmission arrangement comprising:
a carrier substrate with a microstrip transmission line on a first side of the carrier substrate, said carrier substrate further comprising at least one opening forming a waveguide input/output opening to a waveguide arrangement, wherein the microstrip transmission line further comprises a microstrip carrier with a microstrip conductor, a first end of said microstrip conductor at least partly is disposed at one of said waveguide openings with a first conductor portion disposed on said microstrip carrier arranged on said first side of the carrier substrate substantially at the center of said at least one opening and extending in a direction substantially parallel with a longitudinal extension of the transmission arrangement, a second conductor portion extending substantially perpendicularly to said first conductor portion and so disposed that said first and second portions substantially form a T, said second portion via a first bend forming the transfer to a third conductor portion such that said second and third conductor portions form an angle of substantially 90° with each other, said third portion via a second bend forming a transfer to a fourth conductor portion extending substantially parallel with said second conductor portion, a third bend being provided to form a transfer to a fifth conductor portion substantially parallel with said third conductor portion but displaced a distance towards a longitudinal centerline of the transmission arrangement, said distance substantially corresponding to the length of said fourth conductor portion, that on the portion(s) of the substrate comprising the opening(s) associated with said at least one waveguide opening, a respective quarter wavelength (λ/4) waveguide termination is disposed, and in that further an adapting element is arranged substantially at said third bend and in that the arrangement comprises a transition between the microstrip transmission line and a waveguide arrangement.

28. A microwave/millimeterwave transmission arrangement according to claim 27, further comprising an opening forming a second waveguide opening disposed at the opposite side of the longitudinal extension of the transmission arrangement, that said microstrip conductor, at said second waveguide opening, comprises second end first-to-fifth conducting portions and second end first, second and third bends similar to those, first end, conductors/bends associated with said first waveguide opening and located in the same plane, but rotated 180° with respect thereto.

29. A microwave/millimeterwave transmission arrangement according to claim 27, further comprising a power amplifier disposed on the waveguide arrangement such as to cover an intermediate portion of said carrier substrate at a distance from said third bend or bends and in that the fifth conducting portions are connected to said power amplifier.

30. A microwave/millimeterwave transmission arrangement according to claim 27, wherein the carrier substrate comprises a dielectric material with a dielectric constant (∈ᵣ) selected between 2-200.

31. A microwave/millimeterwave transmission arrangement according to claim 27, wherein the carrier substrate further comprises a ferroelectric material.

32. A microwave/millimeterwave transmission arrangement according to claim 27, wherein the microstrip carrier comprises a microstrip laminate.

33. A microwave/millimeterwave transmission arrangement according to claim 32, wherein the conductors comprises Cu, Ag or Au or similar material provided in or on said microstrip laminate.

34. A microwave/millimeterwave transmission arrangement according to claim 32, wherein said microstrip carrier material or laminate comprises Duroid 5870 or a similar material.

35. A microwave/millimeterwave transmission arrangement according to claim 32 wherein the width of the conductor substantially is between 0.99-1.3 mm, particularly about 1.12 mm.

36. A microwave/millimeterwave transmission arrangement according to claim 27 wherein, on the second side of said carrier substrate, a rectangular recess is formed, the height of which corresponds to the height of a waveguide comprised by the waveguide arrangement.

37. A microwave/millimeterwave transmission arrangement according to claim 27, wherein the waveguide arrangement comprises Al or a similar material.

38. A microwave/millimeterwave transmission arrangement according to claim 27, wherein the adapting means are provided close to the, or at each, third bend.

39. A microwave/millimeterwave transmission arrangement according to claim 27, wherein the adapting means are provided substantially at the middle of the, or at each, third bend.

40. A microwave/millimeterwave transmission arrangement according to claim 39, wherein the adapting means comprise Al or an Al-film.

41. A microwave/millimeterwave transmission arrangement according to claim 40, wherein the adapting means comprises a wire or a filament of Al or a material with similar properties.

42. A microwave/millimeterwave transmission arrangement according to claim 41, wherein the wire of Al has a width or thickness of approximately 0.3-0.7 mm preferably about 0.5 mm and a length of approximately 2-6 mm, preferably about 4 mm.

43. A microwave/millimeterwave transmission arrangement according to claim 38, wherein the adapting means are soldered onto the conductor portion at the respective third bend.

44. A microwave/millimeterwave transmission arrangement according to claim 27, wherein said first and second portions substantially assuming the shape of T comprise probes located substantially at the center of the respective waveguide opening.

45. A microwave/millimeterwave transmission arrangement according to claim 27, wherein said third bends are substantially 90° bends, such that interconnected portions are interconnected at substantially 90°.

46. A microwave/millimeterwave transmission arrangement according to claim 27, wherein at least some of the bends provide interconnections for which interconnected conductor portions form an angle with each other exceeding 90°.

47. A microwave/millimeterwave transmission arrangement according to claim 27, implemented as a module.

48. A microwave/millimeterwave transmission arrangement according to claim 47, further comprising Monolithic Microwave Integrated Circuit (MMIC).

49. A microwave/millimeterwave transmission arrangement according to claim 27, implemented in an antenna system.

50. A waveguide arrangement for transmission of microwave/millimeterwaves including a waveguide block with a number of waveguide input/output openings, comprising:
at least, on a number of said waveguide input/output openings microwave/millimeter transmission arrangements, each of said microwave/millimeter transmission arrangements further comprising a carrier substrate with a microstrip transmission line on a first side of the carrier substrate, said carrier substrate further comprising at least one opening forming a waveguide input/output opening to a waveguide arrangement, wherein the microstrip transmission line further comprises a microstrip carrier with a microstrip conductor, a first end of said microstrip conductor at least partly is disposed at one of said waveguide openings with a first conductor portion disposed on said microstrip carrier arranged on said first side of the carrier substrate substantially at the center of said at least one opening and extending in a direction substantially parallel with a longitudinal extension of the transmission arrangement, a second conductor portion extending substantially perpendicularly to said first conductor portion and so disposed that said first and second portions substantially form a T, said second portion via a first bend forming the transfer to a third conductor portion such that said second and third conductor portions form an angle of substantially 90° with each other, said third portion via a second bend forming a transfer to a fourth conductor portion extending substantially parallel with said second conductor portion, a third bend being provided to form a transfer to a fifth conductor portion substantially parallel with said third conductor portion but displaced a distance towards a longitudinal centerline of the transmission arrangement, said distance substantially corresponding to the length of said fourth conductor portion, that on the portion(s) of the substrate comprising the opening(s) associated with said at least one waveguide opening, a respective quarter wavelength (λ/4) waveguide termination is disposed, and in that further an adapting element is arranged substantially at said third bend and in that the arrangement comprises a transition between the microstrip transmission line and a waveguide arrangement.

51. A waveguide arrangement, according to claim 50, further comprising means for providing a transition to a coaxial transmission arrangement.

52. A waveguide arrangement, according to claim 50, implemented in an antenna system.
